(19) United States
(12) Patent Application Publication
(10) Pub. No.: US 2009/0302510 A1
(43) Pub. Date: Dec. 10, 2009

(54) METHOD AND EQUIPMENT FOR DECREASING THE CYCLE TIMES OF MACHINES FOR PRODUCING ARTICLES IN THERMOPLASTIC MATERIAL

(76) Inventors: Fabrizio Castellari, Bologna (IT); Moreno Minghetti, Montecarlo (MC); Emmanuel Velut, Lons Le Saunier (FR)

Correspondence Address: STITES & HARBISON PLLC, 1199 NORTH FAIRFAX STREET, SUITE 900, ALEXANDRIA, VA, 22314, US

(21) Appl. No.: 12/306,582

(22) PCT Filed: Jun. 22, 2007
(86) PCT No.: PCT/EP07/56267

§ 371 Date: Dec. 24, 2008

(30) Foreign Application Priority Data
Jun. 29, 2006 (IT) BO2006A000499

(51) Int. Cl. B29C 49/00; B29C 49/28

(52) U.S. Cl. 264/528; 425/526

(57) ABSTRACT

The method comprises the following sequence of stages of operation: feeding the blowing air into the parison enclosed in the mould (1), with the maximum pressure characteristics required for the blow moulding thermoforming cycle, and maintaining this blowing condition for a minimum period depending on the characteristics of the container to be produced; reducing the blowing air pressure to a specified minimum level sufficient to keep the blown container adhering to the inner walls of the mould (1) which contains and shapes it; discharging the blowing air at low pressure from the inside of the blown container, in such a way that the inner surface of the container is bathed by a flow of air which is constantly renewed at the appropriate flow rate, which rapidly reduces the internal temperature of the container, while the external temperature of the container is reduced by contact with the walls of the mould (1) which are cooled by the forced circulation of a cooling fluid; interrupting the blowing cycle and the said cycle for the discharge of the cooling air at low pressure, and appropriately reducing the pressure inside the formed container, in such a way that the container can be discharged from the mould which can be prepared for the execution of a new operating cycle.

### DESCRIPTION

The invention relates to systems for the blow moulding thermoforming of hollow articles such as phials, bottles and containers in general, in which an extruded piece of hot thermoplastic material, known as a parison, leaving the extruder is trapped between a mould and a counter-mould, and air is then blown into the parison at appropriate pressures, thus rapidly inflating the parison and making it adhere closely to the inner walls of the mould and counter-mould assembly, to form the container with the specified shape and capacity. The mould and counter-mould are subsequently opened and transferred to the station for collecting a new parison, while the formed container remains attached to the blowing nozzle from which it is removed by suitable means and is then transferred to sizing means and then to other stations for flash removal, finishing and inspection.

The production of a blow moulding thermoforming machine is closely determined by the cooling capacity and speed of the mould and counter-mould unit and of the containers which are cyclically formed, since, before the unit can be opened, the containers must be brought to a specified minimum temperature, so that when they are removed from the mould they are sufficiently self-supporting and are not subjected to significant permanent deformation in the course of cooling to ambient temperature. The forming cycle times are determined by the weight/volume ratio of the formed container and therefore by the thickness of the walls of the container.

To reduce these cycle times, the present solutions are primarily directed towards providing the mould and counter-mould unit with a good capacity for the fast dissipation of the heat generated by the extruded and blown parison inside this unit. This limits of this solution are due to the fact that the cooling is primarily induced on the outer wall of the container, because only this wall is in contact with the cooled mould, and because the plastics material from which the container is made is an inherently thermally insulating material, which does not promote the desirable transfer of heat from the inside to the outside. Therefore, although the temperature of the outer walls of the container can easily and rapidly be reduced to 50-20° C., depending on the thickness of different areas of the walls of the container, the temperature inside the container tends to remain at about 90-80° C., and even if the opening of the mould and counter-mould is delayed, no appreciable improvements are obtained.

To overcome the limits imposed by cooling only the outside of containers thermoformed by blow moulding, solutions have now been devised for blowing with cold air, at temperatures down to about −40° C. for example. This solution gives rise to considerable additional costs and problems relating to the air cooling equipment. This solution also gives rise to condensation phenomena which are difficult to control, and only partially resolves the cooling problem, since the volume of cold air injected into the container is rapidly heated in the absence of any form of recirculation. The low temperature of the blowing air subjects the inner surface of the thermoformed container to heat shock, leading to the formation of microcracks which reduce the mechanical strength of the container.

In an attempt to provide sufficient and rapid internal cooling of the blown container, with low operating costs, it has now also been proposed that the rod of the blowing station be provided with a very small controlled discharge, making it possible to operate rapidly with the blowing pressure at the specified high level while also permitting a very small circulation of air in the container during the blowing, which improves the internal cooling of this container. In combination with this solution, or as an alternative to it, post-cooling solutions have also been proposed, in which the container is cooled with ambient air at very low pressure, after the stage of removal from the mould and up to the stage of flash removal from the container. However, even with these solutions it is impossible to reduce the cycle times appreciably, since if the bottle is removed from the mould with a high internal temperature, the bottle will tend to become deformed after production, especially if it is flat.

The invention is intended to overcome the aforesaid technical problem, in other words that of substantially reducing the cycle time of a blow moulding thermoforming machine, with a method and equipment according to Claim 1 and the subsequent dependent claims, based on the following proposal for a solution. The blowing rod is provided in its lower part, which is inside the upper part of the container and from which a suitable blowing nozzle projects, with discharge holes or apertures connected to a circuit intercepted by valve means which are closed at the start of cycle in such a way that compressed air at the highest specified pressure can be injected rapidly into the parison. A few moments after the start of the cycle, the pressure of the blowing air is reduced to levels sufficient to ensure good adhesion of the plastics material to the inner walls of the mould, and the said valve means of the said discharge circuit are opened in such a way that the blowing air at low pressure flows into the container, at flow rates sufficient to provide a rapid internal cooling of the blown container. The blowing nozzle is extended into a position which is sufficiently low to effectively cool the closed bottom of the container, where there is usually a concentration of material, and to allow the free upward flow of the air which, before flowing out, effectively bathes the neck of the container, where there is a high concentration of material, at temperatures which are also very high at this point. The blowing air is suitably cooled, for example by using an air/liquid heat exchanger into which the cooling liquid leaving the mould and counter-mould unit is made to flow, this air usually being at relatively low levels. The air which internally cools the blown container and which is channelled by the discharge circuit can be used subsequently to cool the containers in the operating stages following the blowing stage, for example in the flash removal stage, for cooling the waste material present on the bottoms and necks of the containers formed in the preceding cycles. In the novel solution, which requires an air consumption greater than that of the known methods, but which can be limited to an increase of about 10-15% because of the low pressure, the cycle times can be reduced by about 10-40%, depending on the thickness of the walls of the formed container, owing to the better internal cooling of the container, achieved as stated above, and owing to the practically zero time required to discharge the residual air from the container before the stage of opening the mould and counter-mould unit, since, in the final part of the cycle, the blowing takes place at a very low pressure, close to atmospheric pressure.

These and other characteristics of the invention, and the advantages resulting therefrom, will be made clearer by the following description of a preferred embodiment of the invention, illustrated purely by way of example and without restrictive intent in the figures on the attached sheet of drawing, in which:

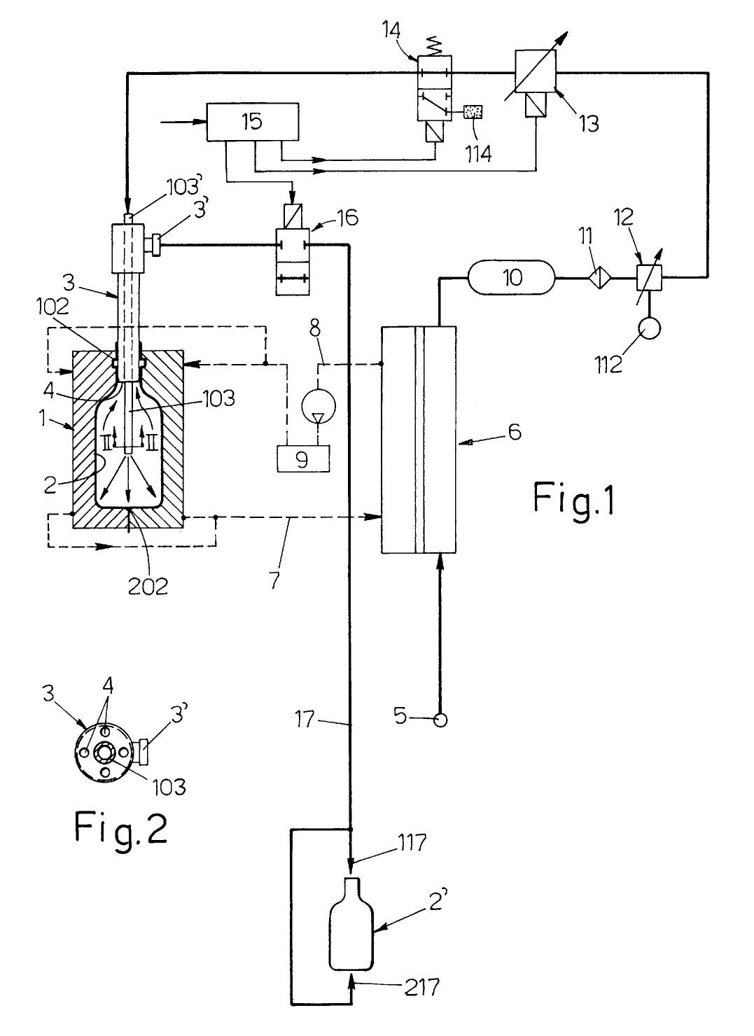

FIG. 1 shows a simplified circuit diagram of the equipment according to the invention;

FIG. 2 shows details of a rod with a blowing nozzle, in a view taken along the section II-II of FIG. 1.

In FIG. 1, the number 1 indicates the mould and counter-mould unit which for the sake of simplicity will be referred to simply as a “mould” in the following text. The number 2 indicates the container being formed in the mould 1, and 3 indicates the rod of the blowing station, which passes with a seal through the neck area 102 of the container; has a shape and dimensions matched to those of the neck 102 to be formed; terminates at a short distance from the inner part of the neck 102, and on this base carries a projecting blowing nozzle 103 which preferably has a length such that its lower discharge end is as close as possible to the bottom 202 of the container, where there is usually a concentration of plastics material at high temperatures. The blowing rod 3 is made in a hollow shape, so as to form, around the portion of nozzle 103 which passes through it and projects from it with its inlet opening 103′, an annular gap having one end connected to an inlet orifice 3′, while its other end opens inside the container 2, by means of one or more holes or apertures 4, as shown in FIG. 2.

The blowing air taken from a compression source which is not illustrated and is schematically indicated by 5, passes through a heat exchanger 6 of the air/liquid type, which is highly economical and reliable, and in which the liquid from the discharge branch 7 of the cooling circuit of the mould 1 is made to flow, this liquid having an average temperature of about 9° C., so that, as a result of the exchange, the ambient air can be cooled to an average temperature of about 15° C. The outlet branch 8 of the heat exchanger 6 leads to the known unit 9 which feeds the cooling liquid at the usual temperature, for example about 8° C., to the mould 1. Clearly, the circuit 7, 8, 9 as indicated is purely exemplary and can be of any type, since it is not related to the understanding of the invention. The fresh compressed air leaving the heat exchanger 6 is accumulated in a reservoir 10, and flows through a filter 11 and then through a pressure regulator 12 with a corresponding pressure gauge 112 by means of which the air is set to the specified maximum operating pressure, which for example is about 8-12 bars, after which the said pressurized air flows through a controlled pressure regulator 13 and a solenoid valve 14 which has at least an on/off function (see below) and finally reaches the inlet aperture 103′ of the blowing nozzle 103. The components 13 and 14 are controlled by a process unit indicated schematically by the number 15, which takes account of the different variables of the production cycle and which also controls a valve means 16 consisting, for example, of a solenoid valve of the on/off or modulated opening type, connected to the outlet aperture 3′ of the rod 3 of the blowing station. The outlet of the latter valve means is connected to a circuit 17 which terminates in discharge nozzles 117, 217 located in one or more stations of the thermoforming machine following the forming station, for example in the flash removal and/or other stations, to cool the typically hotter neck and bottom areas of the containers formed in the preceding cycles.

The equipment as described operates in the following way. At the start of the blow moulding thermoforming cycle, the discharge solenoid valve 16 is in the off state shown in FIG. 1, and therefore, when the feed solenoid valve 14 is switched to the “on” state, the blowing nozzle 103 can rapidly inject the quantity of air at the specified maximum operating pressure, for example 8-12 bars, into the parison enclosed in the mould 1. The cycle remains in these conditions for a limited time, depending on the characteristics of the container to be produced, after which the controlled pressure regulator 13 is actuated to substantially reduce the pressure of the blowing air to a level of a few bars, for example about 2-3 bars, and at the appropriate time the discharge solenoid valve 16 is switched to the “on” condition, in such a way that a flow of fresh air, at about 15° C. for example, flows through the inside of the blown container 2, cooling it effectively because this flow is constantly renewed. The air leaving the circuit 16, 17 at a temperature of about 30-40° C. is discharged from the nozzles 117, 217 and, for example, cools containers 2′ formed in the preceding cycle. To enable the cooling cycle to be carried out correctly, the cross section of the discharge circuit which comprises the valve 16 and the circuit 17 must be equal to or greater than the cross section of the portion of circuit which lies upstream of the valve 16, and which starts from the discharge holes 4 of the rod 3, in such a way that the air flows out with substantially no resistance. This internal cooling condition is maintained for an appropriate period which depends on the characteristics of the formed container, after which the inlet solenoid valve 14 is switched to the position in which the blowing nozzle 103 is disconnected from the controlled pressure regulator 13 but is connected to a free exhaust system, with a silencer 114, in such a way that the residual air in the bottle can be rapidly discharged to the outside, after which the mould 1 can be made to open for the removal of the formed container. The said stage of discharging the residual air into the bottle takes place in a much shorter period than in the commonly used systems, owing to the lower residual pressure inside the bottle and the possibility of making the air flow out not only through the circuit 103, 14, 114 but also through the holes 4, the valve 16 and the circuit 17.

Clearly, the invention is to be considered as protected even if it is used in machines for producing sealed containers, in which an appropriate vacuum is created before the stage of removal from the mould 1. In this case also, there is the advantage that the specified degree of vacuum can be achieved more rapidly inside the formed containers.

In return for an air consumption which is about 10-15% higher than the consumption of current systems, and the addition of a few components, the equipment according to the invention can reduce the blowing cycle times by about 10-40%, with the evident economic advantages resulting from this.

1. Method for reducing the cycle times of machines for producing containers or other hollow articles from thermoplastics materials, by the blow moulding thermoforming process, characterized by the following sequence of stages of operation:
Feeding the blowing air into the parison enclosed in the mould, with the maximum pressure characteristics required for the blow moulding thermoforming cycle, and maintaining this blowing condition for a short period, depending on the characteristics of the container to be produced;
Reducing the pressure of the blowing air to a specified minimum level which is sufficient to keep the blown container adhering to the inner walls of the mould which contains and shapes it;
Discharging the blowing air at low pressure from the inside of the blown container, in such a way that the inner surface of the container is bathed by a flow of air which is constantly renewed at the appropriate flow rate, which rapidly reduces the internal temperature of the container, while the external temperature of the container is reduced by contact with the walls of the mould which is cooled by the forced circulation of a cooling liquid;
Interrupting the blowing cycle and the said cycle of discharge of the cooling air at low pressure, and appropriately reducing the pressure inside the formed container, in such a way that the container can be discharged from the mould which can be prepared for the execution of a new operating cycle.

2. Method according to claim 1, in which the blowing of the containers in the mould is carried out with suitably cooled ambient air.

3. Method according to claim 2, in which the blowing air is cooled by heat exchange with the mould cooling liquid.

4. Method according to claim 1, in which the blowing air is injected into an area of the container being formed which is sufficiently close to the bottom of the container so as to cool the bottom without restricting the outflow of the blowing air from a discharge area, which is positioned in the vicinity of the neck of the same container.

5. Method according to claim 1, in which the low-pressure cooling air leaving the blown container is used to cool hot areas of the blow moulding thermoforming machine and/or the containers progressively formed in the machine.

6. Equipment for reducing the operating cycle times of machines for producing articles from plastics material by the blow moulding thermoforming process, characterized in that it comprises:
Means for feeding the blowing air into the parison enclosed in the mould, with the maximum pressure characteristics required for the blow moulding thermoforming cycle, and for maintaining this blowing condition for a short period, depending on the characteristics of the container to be produced;
Means for reducing the pressure of the blowing air to a specified minimum level which is sufficient to keep the blown container adhering to the inner walls of the mould which contains and shapes it;
Means for discharging the low-pressure blowing air from the inside of the blown container, in such a way that the inner surface of the container is bathed by a flow of air renewed constantly or in a pulsating way and with appropriate flow rates, which rapidly reduces the internal temperature of the container;
Means for interrupting the said blowing stage and the said stage of discharging the low-pressure cooling air at the appropriate time, and means for providing the necessary pressure reduction inside the formed container, in such a way that the container can be discharged and the mould can be prepared for the execution of a new operating cycle.

7. Equipment according to claim 6, characterized by the use in the blowing station of a rod which passes with a seal through the area of the neck of the container cyclically formed by blow moulding in the mould; has a shape and dimensions matched to those of the said neck to be formed; preferably terminates with its base at a short distance from the inner part of this neck, and carries on this base a projecting blowing nozzle which preferably has a length such that its lower discharge end is as close as possible to the bottom of the said container, where there is usually a concentration of plastics material, at high temperatures, the said rod being made in a hollow shape, so as to form, around the portion of nozzle passing through it and projecting from it with its inlet end, an annular gap having one end connected to an inlet opening while its other end opens into the said thermoformed and blow moulded thermoformed container with one or more holes or apertures.

8. Equipment according to claim 6, in which use is made of a heat exchanger of the air/liquid type which is highly economical and reliable, in which a cooling liquid, taken for example from the discharge branch of the cooling circuit of the mould, is made to flow, and in which exchanger the ambient air taken from a supply source at appropriate pressure levels is made to flow, in such a way that, as a result of the heat exchange, the air is cooled to precise temperatures, the air leaving the exchanger being, for example, accumulated in a suitable reservoir, and then made to flow through a filter and then through a pressure regulator, for adjustment to the maximum levels required for the blow moulding thermoforming process, after which the said pressurized air passes through a controlled pressure regulator and a solenoid valve having for example at least an on/off function, and finally reaches the inlet aperture of the blowing nozzle.

9. Equipment according to claim 8, in which the said components are controlled by a process unit which takes account of the different variables of the production cycle and which also controls a solenoid valve, of the on/off or modulated opening type for example, connected to the outlet aperture of the rod of the blowing station.

10. Equipment according to claim 9, in which the outlet of the said last solenoid valve is connected to a circuit which terminates in the discharge nozzles located in the stations of the thermoforming machine following the forming station, for example in the flash removal station and/or other stations, to cool the typically hotter areas of the containers formed in the preceding cycles.

11. Equipment according to claim 8, characterized in that it comprises means to ensure that, at the start of the blow moulding thermoforming cycle, the said discharge solenoid valve is closed in such a way that, when the said blowing air delivery solenoid valve is open, the blowing nozzle can rapidly inject the quantity of air at the specified maximum operating pressure, for example 8-12 bars, into the parison enclosed in the mould, the cycle being made to remain in these conditions for a short time, depending on the characteristics of the container to be produced, after which the said controlled pressure regulator is actuated to substantially reduce the pressure to a level of a few bars, for example about 2-3 bars, and at the appropriate time the said discharge solenoid valve is opened in such a way that an ample flow of fresh air flows through the inside of the blown container, cooling it suitably, while the air leaving the cooling circuit at a temperature which on average is about 30-40° C., for example, is discharged from the said nozzles to cool, for example, the containers formed in the preceding cycle, means being provided to maintain this condition for an appropriate time which depends on the characteristics of the container produced, after which the said solenoid feed valve is switched to a position in which the blowing nozzle is disconnected from the controlled pressure regulator but is connected to a free exhaust system, with a silencer, in such a way that the residual air in the bottle can be rapidly discharged to the outside, possibly through the circuit of the rod and its valve, to enable the mould to be opened subsequently for the removal of the containers produced.

12. Equipment according to claim 9, in which the cross section of the discharge circuit which comprises the said valve and the said circuit with the said nozzles is equal to or greater than the cross section of the portion of circuit which lies upstream of the valve, and which starts from the discharge holes of the blowing rod, in such a way that the air flows out with substantially no resistance from the container during cooling.

13. Equipment according to claim 6, characterized in that it is designed to operate in machines producing initially closed containers, in which an appropriate vacuum is created internally before the stage of removal from the mould.
